(19) United States
(12) Patent Application Publication
(10) Pub. No.: US 2006/0064399 A1
(43) Pub. Date: Mar. 23, 2006

(54) Method and system for testing distributed software applications

(76) Inventor: Giuseppe De Sio, Rome (IT)

Correspondence Address: IBM CORPORATION;INTELLECTUAL PROPERTY LAW, 11400 BURNET ROAD, AUSTIN, TX, 78758, US

(21) Appl. No.: 11/230,338

(22) Filed: Sep. 20, 2005

(30) Foreign Application Priority Data
Sep. 21, 2004 (EP) 04104554.3

(51) Int. Cl. G06F 17/30

(52) U.S. Cl. 707/1

(57) ABSTRACT

A method for testing a web application (250,275-280) is proposed. The test process is controlled by an automation server (120), which transmits any request of loading a web page (265) to an automation agent (240) running on a corresponding test client (110). The automation agent updates the request (so as to act as a web proxy) and forwards it to a browser (250); in response thereto, the browser requests the web page to the automation agent. The automation agent downloads the web page from a corresponding test server (105) and updates it by injecting an automation applet (270). In this way, when the web page is interpreted by the browser the automation applet is downloaded and launched. The automation server can now transmit any desired command for the web page to the automation agent; the automation agent in turn forwards the command to the automation applet, which controls its execution on the web page by using the LiveConnect technology.

### TECHNICAL FIELD

The present invention relates to the data processing field. More specifically, the present invention relates to a method for testing a distributed software application. The invention further relates to a computer program for performing the method, and to a product embodying the program. Moreover, the invention also relates to a corresponding data processing system.

### BACKGROUND ART

The test of software applications is a very critical activity. The problem is particular acute in distributed software applications, which run in a complex and heterogeneous network environment. A typical example is that of web applications. A web application consists of a solution that is delivered over the World Wide Web (or simply web). The web consists of a system of server computers in the Internet, which servers support specially formatted documents (called web pages). Each web page is a hypertext document defined in the HyperText Markup Language (HTML), which provides links to other documents, as well as graphics, audio, and video files. Any user can access the web application through a client computer, which must be equipped with a browser program allowing the user to locate and display the web pages.

The web applications have become very popular in the last years, due to the ubiquity of the browsers; another reason of the widespread diffusion of the web applications is the possibility of maintaining them without the need of performing any action on the clients.

However, the task of testing a web application is very complex. First of all, the web application must be exercised on several computers with a multitude of hardware and/or software platforms; particularly, the clients can be equipped with different operating systems and can use different browsers.

A further difficulty derives from the multilevel logic of the web application. Indeed, in a very simple situation all the users access the servers in the same way. However, in most practical situations different categories of users are available. For example, the web application provides restricted sections for administrators (which access is denied to ordinary users); in this case, the web application also implements specific interfaces for the administrators and the ordinary users. Therefore, the test process requires different operations on different environments in a predefined order. In a far more complex scenario, an action performed on a specific client can have an impact somewhere else in the system. For example, any attempt to access a restricted section of the web application by a non-authorized user causes the log of an exception, which is then available for off-line analysis by the administrators (through a dedicated interface). In order to test this scenario it is necessary to perform more complex operations (such as read files, access databases, and the like).

The above-mentioned drawbacks hinder the automation of the test process; therefore, the test of complex web applications requires a heavy human intervention. However, this solution has a detrimental impact on the cost of the test process. All of the above restricts the use of the test process, and accordingly lowers the level of quality and reliability of the web applications.

### SUMMARY OF THE INVENTION

According to the present invention, the dynamic association of an automation component with each page is suggested.

Particularly, an aspect of the present invention provides a method for testing a distributed software application; the software application runs on one or more test clients and one or more test servers. For each test client, the method includes the following steps. At first, an automation server transmits a request of opening a page (stored on a corresponding test server) to an automation agent running on the test client. The automation agent causes the loading of the page with the addition of an automation component. The automation server then transmits a command for the page to the automation agent. The automation agent passes the command to the automation component. At the end, the automation component causes the execution of the command on the page.

The proposed solution strongly simplifies the task of testing the software application.

Indeed, the automation component can be defined so as to run on multiple hardware and/or software platforms; in this way, it is possible to exercise test clients that are equipped with different operating systems or use different browsers.

Moreover, this solution well fits any multilevel logic of the software application. Particularly, the method can be used to test a multitude of scenarios, from simple situations wherein all the users have the same characteristics to more complex scenarios with different categories of users (wherein several operations, even of different type, must be performed on different environments in a predefined order).

The above-described solution facilitates the automation of the test process (strongly reducing any human intervention). As a result, the cost of the test process is substantially reduced. Therefore, the devised solution fosters the widespread use of the test process, and accordingly increases the level of quality and reliability of the software applications.

The preferred embodiments of the invention described in the following provide additional advantages.

For example, the request of the page is updated by the automation agent to have a browser to contact the same automation agent for downloading the page (which is then updated to cause the loading of the automation component).

As a result, the automation agent acts as a proxy for the browser (thereby facilitating the automation of the operations to be performed on the page).

For this purpose, a suggested choice is that of inserting a code portion into the page, which code portion causes the browser to fetch and run the automation component during the interpretation of the page.

The proposed feature allows achieving the desired results with a very low impact on the software application to be tested.

Advantageously, the automation component is stored on the same test server providing the page.

This prevents any security exception (which could be raised when the location of the automation component is different from the one of the page).

In a preferred embodiment of the invention, the automation component listens on a connection with the automation agent.

Therefore, the communication between the automation agent and the automation component is very simple but at the same time effective.

A way to further improve the solution is to generate a unique identifier for the automation component.

This identifier is used by the automation agent to distinguish different automation components, thereby allowing multiple instances of the browser to run concurrently on the same test client.

As an additional enhancement, the automation agent inserts a further code portion into the page; this code portion causes the browser to notify the completion of the loading of the page to the automation agent (which in turn forwards the notification to the automation server).

The devised feature is very useful for synchronizing the test process.

A further aspect of the present invention provides a computer program for performing the above-described method.

A still further aspect of the invention provides a program product embodying this computer program.

Moreover, another aspect of the invention provides a corresponding data processing system.

The novel features believed to be characteristic of this invention are set forth in the appended claims. The invention itself, however, as well as these and other related objects and advantages thereof, will be best understood by reference to the following detailed description to be read in conjunction with the accompanying drawings.

### BRIEF DESCRIPTION OF THE DRAWINGS

FIG. 1a is a schematic block diagram of a data processing system in which the method of the invention is applicable;

FIG. 1b shows the functional blocks of a generic computer of the system;

FIG. 2 depicts the main software components that can be used for practicing the method;

FIGS. 3a-3e show a diagram describing the flow of activities relating to an illustrative implementation of the method.

### DETAILED DESCRIPTION OF THE PREFERRED EMBODIMENT(S)

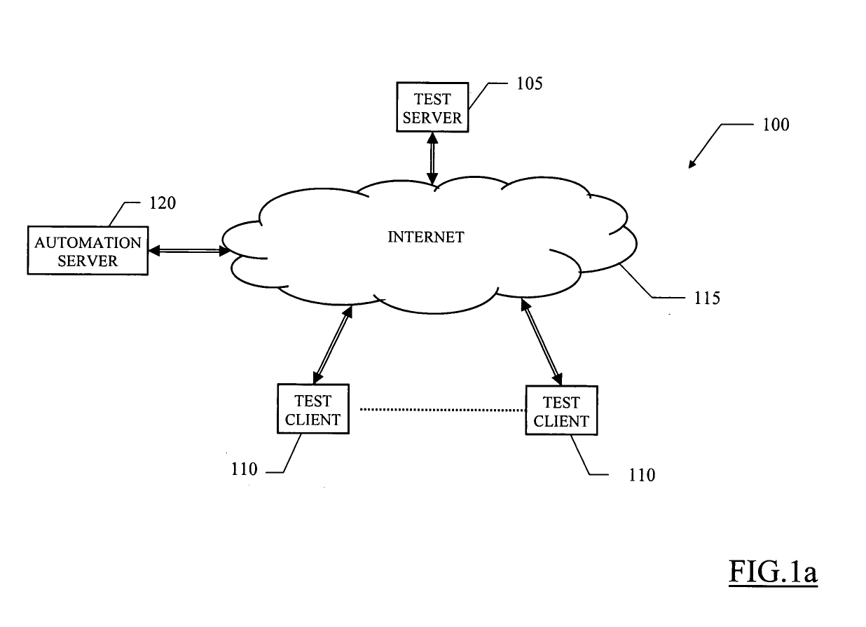

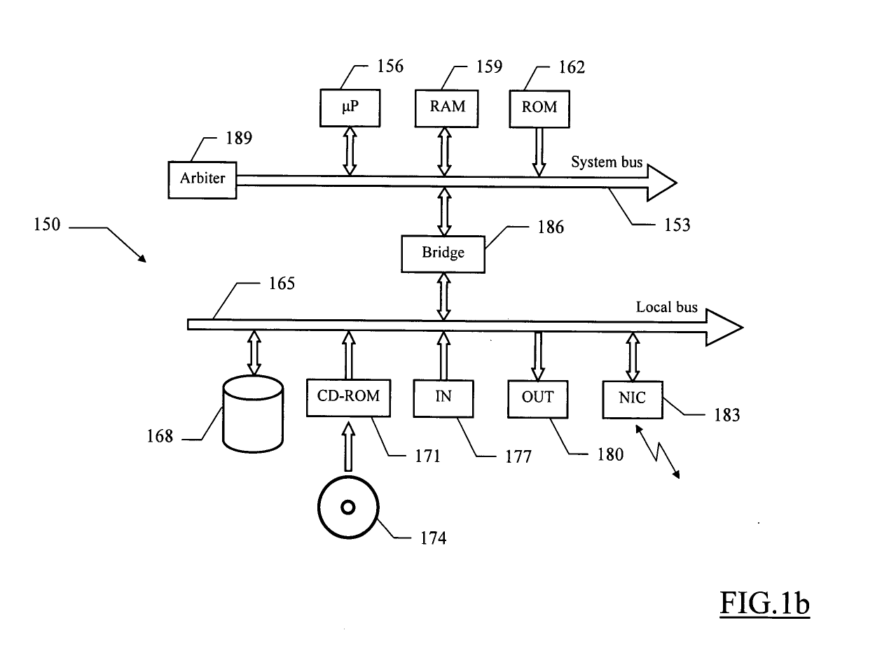

With reference in particular to FIG. 1a, a data processing system 100 with distributed architecture is illustrated. The system 100 defines a test environment, which is used to exercise a distributed software application for identifying any differences between expected and actual behavior.

The software application has a client/server architecture. Particularly, one or more test servers 105 (only one shown in the figure) provide shared resources (such as pages on a web server, archives in a database server, packages in a software distribution server, and the like). Multiple test clients 110 access those shared resources through a communication network 115 (typically Internet-based). The system 100 further includes an automation server 120, which controls the process of testing the software application.

As shown in FIG. 1b, a generic computer of the system (test client, test server or automation server) is denoted with 150. The computer 150 is formed by several units that are connected in parallel to a system bus 153. In detail, one or more microprocessors (μP) 156 control operation of the computer 150; a RAM 159 is directly used as a working memory by the microprocessors 156, and a ROM 162 stores basic code for a bootstrap of the computer 150. Peripheral units are clustered around a local bus 165 (by means of respective interfaces) Particularly, a mass memory consists of a hard disk 168 and a drive 171 for reading CD-ROMs 174. Moreover, the computer 150 includes input devices 177 (for example, a keyboard and a mouse), and output devices 180 (for example, a monitor and a printer). A Network Interface Card (NIC) 183 is used to connect the computer 150 to the network. A bridge unit 186 interfaces the system bus 153 with the local bus 165. Each microprocessor 156 and the bridge unit 186 can operate as master agents requesting an access to the system bus 153 for transmitting information. An arbiter 189 manages the granting of the access with mutual exclusion to the system bus 153.

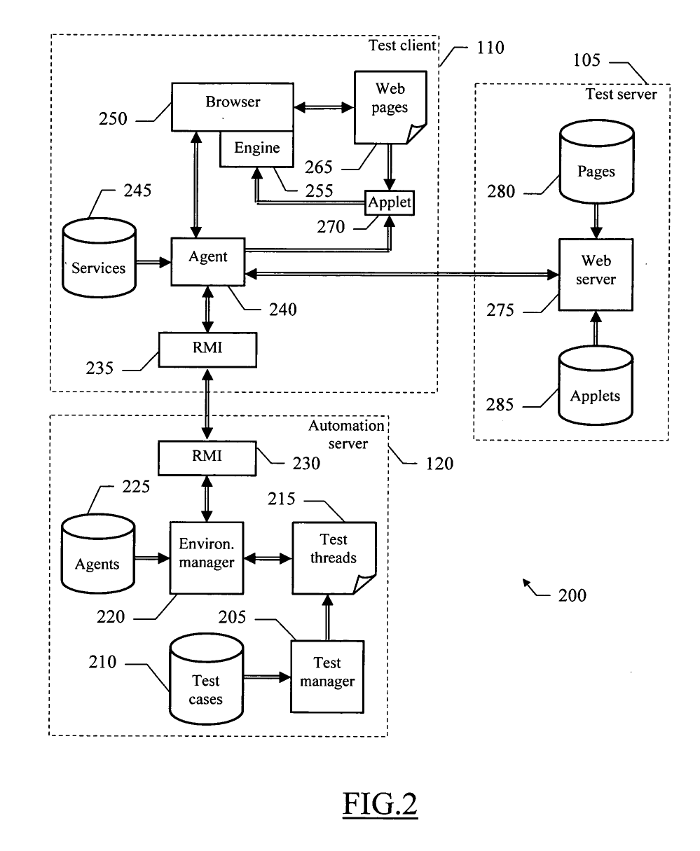

Moving now to FIG. 2, the main software components that can be used for practicing the invention are denoted as a whole with the reference 200. The information (programs and data) is typically stored on the hard disks and loaded (at least partially) into the corresponding working memories when the programs are running. The programs are initially installed onto the hard disks from CD-ROMs.

Considering in particular the automation server 120, a test manager 205 controls the execution of test cases that are stored in a corresponding repository 210. Each test case consists of a sequence of instructions, which specifies the execution of desired operations on selected test clients. The test cases can be grouped into buckets (for example, by functional areas of the software application under test); in this hypothesis, each test case also specifies possible dependencies from other (prerequisite) test cases of the bucket. The test cases are executed by corresponding threads 215 (with multiple test threads 215 that run concurrently during the execution of a bucket).

For this purpose, each test thread 215 interfaces with an environment manager 220. The environment manager 220 owns an agent database 225. The agent database 225 specifies whether each test client is available; moreover, the agent database 225 also indicates whether the test client is already locked by any test case (so as to ensure that the test clients are accessed with mutual exclusion by the different test threads 215). The environment manager 220 controls all the interactions between the test threads 215 and the test clients through a Remote Method Invocation (RMI) layer 230; particularly, the RMI layer 230 is used to invoke methods on remote objects located on the test clients (using the Java language).

A generic test client 110 is provided with a corresponding RMI layer 235, on top of which an automation agent 240 runs. The automation agent 240 consists of an RMI server exporting a service handler method. The automation agent 240 can execute different services (for example, to read a file, to update a database, to print a document, and the like). Each service is implemented by a Java class 245, which is loaded dynamically when the corresponding service is requested by the automation server 120.

The test client 110 also includes a browser 250, which is provided with a plug-in engine 255 enabling the browser 250 to execute instructions written in the JavaScript language. The JavaScript is an interpreted language, which instructions are executed one at a time by a corresponding interpreter (i.e., the engine 255). Therefore, those instructions can be executed on different hardware and/or software platforms (provided that the corresponding engine 255 is embedded in the browser 250). The above-described environment is very common, so that the JavaScript instructions can be interpreted substantially on any test client.

The browser 250 is generally used to surf through the Internet, in order to load desired web pages 265. Each web page consists of a hypertext document formatted in the HTML. Particularly, the HTML supports a tag for embedding the code of scripts (consisting of a series of commands written in the JavaScript language). Another HTML tag can be used to identify external applets 270 (consisting of small programs written in the Java language). The applets run on top of a Java Virtual Machine (JVM) within the browser 250; the JVM provides a runtime environment independent of the underlying hardware and software platform of the test client.

As described in detail in the following, the automation agent 240 also acts as a web proxy for the browser 250. As a result, the browser 250 addresses the request of any new web page to the automation agent 240, which manages its downloading from the corresponding test server.

A generic test server 105 (operating as a web server) is provided with a corresponding module 275; the web server 275 is used to satisfy requests submitted by the test clients and to deliver corresponding web pages. For this purpose, the web server 275 accesses a repository 280, which stores static web pages or templates for building dynamic web pages. Moreover, the web server 275 also controls the fetching of applets 285 requested by the test clients.

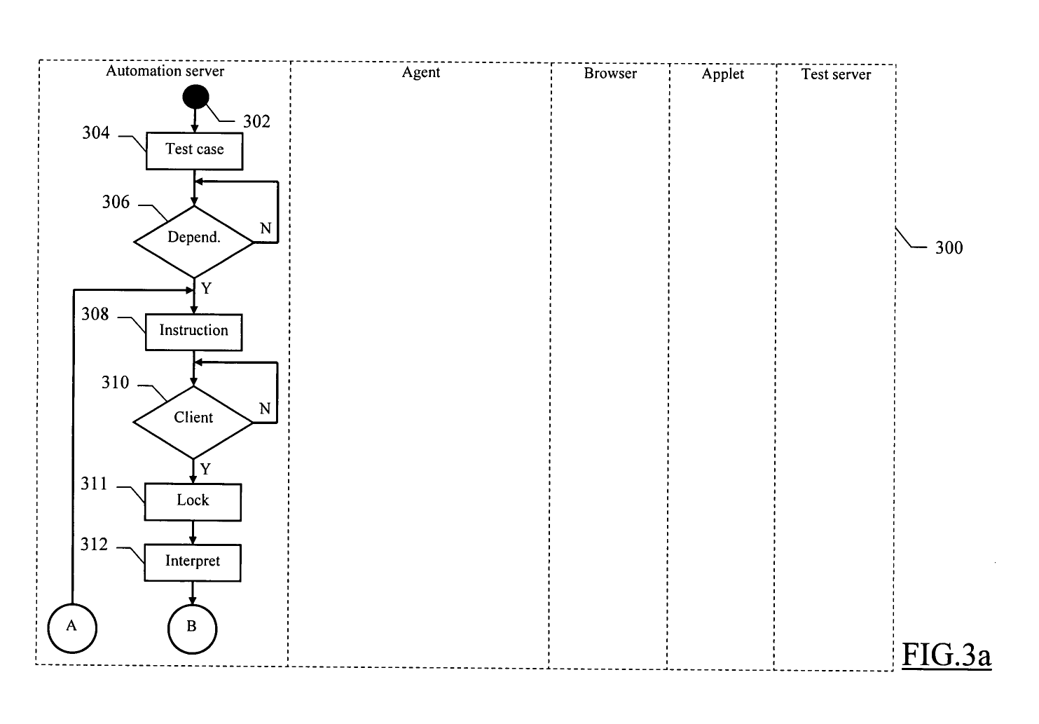

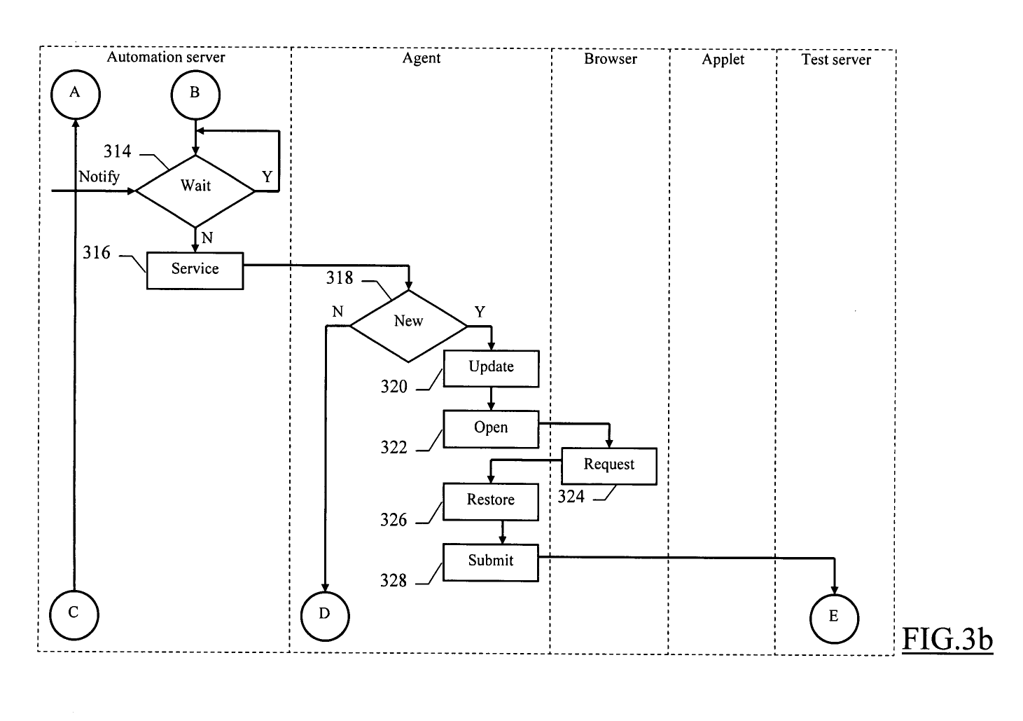

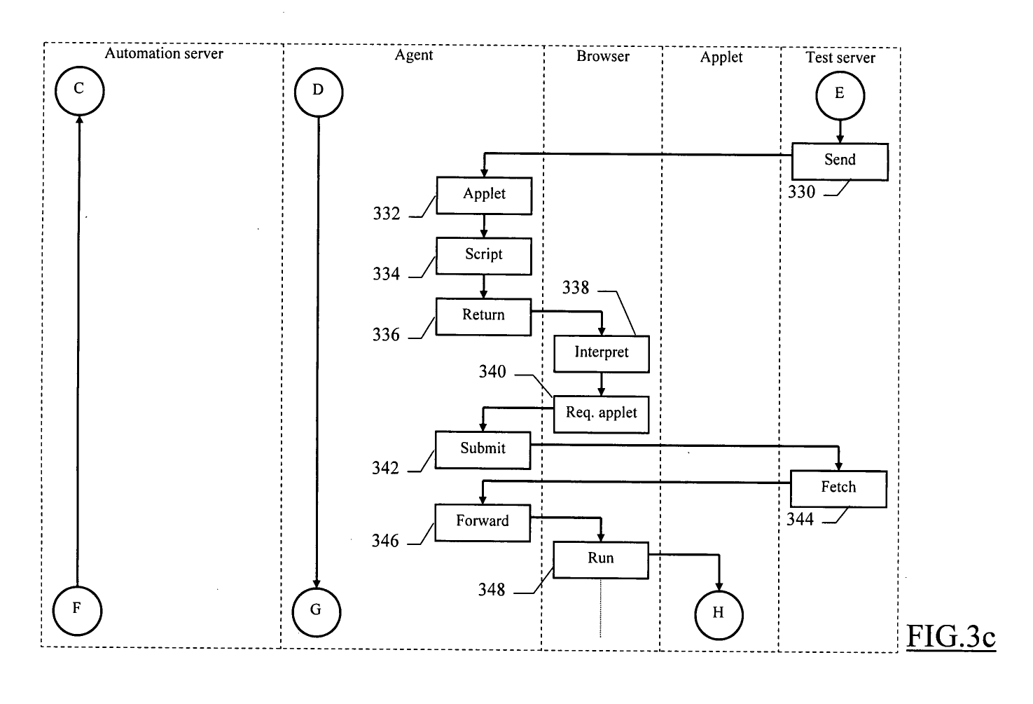

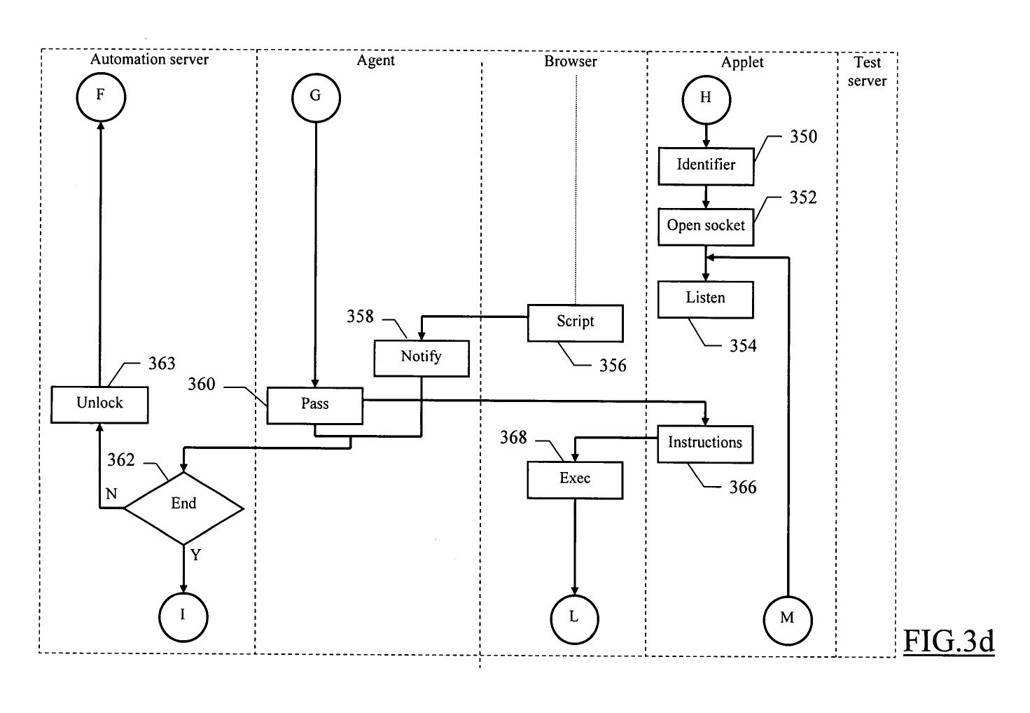

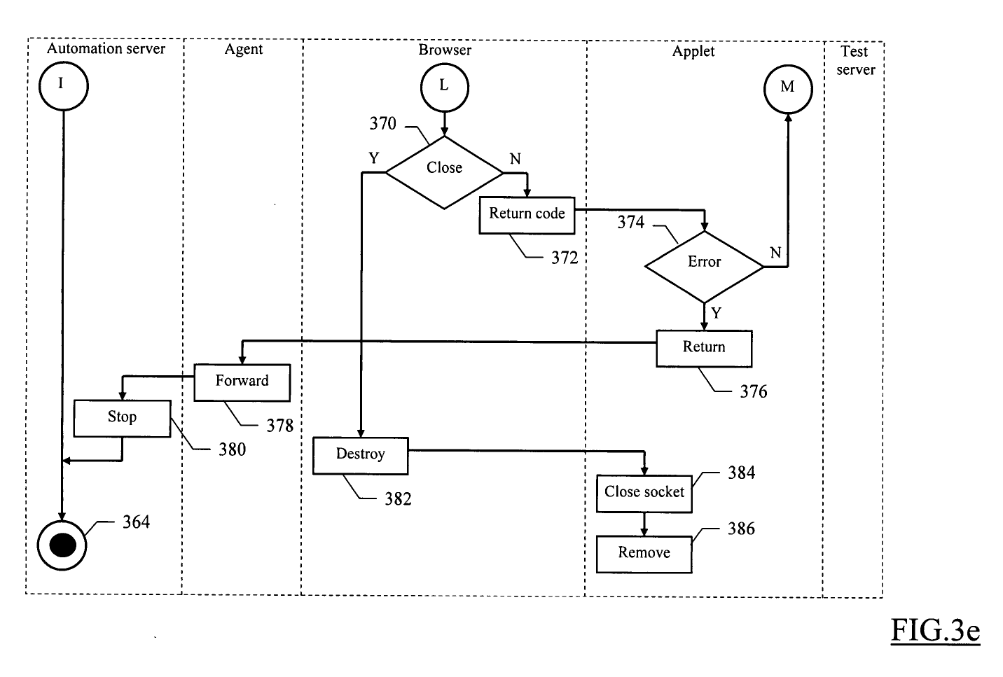

Considering now FIGS. 3a-3e, the logic flow of a test process according to an embodiment of the invention is represented with a method 300. The method begins at the black start circle 302 in the swim-lane of the automation server. Passing to block 304, a selected test case is started with the corresponding thread. The method then verifies at block 306 whether the execution of the test case is conditioned by any dependency. If so, the method loops at block 306 until all the dependencies of the test case are satisfied. As soon as the prerequisite test cases (if any) have been completed, the flow of activity descends into block 308. For each instruction of the test case (starting from the first one), the test client on which the instruction must be executed is identified. Continuing to block 310, the method enters an idle loop, which is exited as soon as the test client can be accessed. As a result, the test client is locked at block 311.

Proceeding to block 312, the instruction is then interpreted. If the instruction consists of a condition that is used to synchronize the execution of the test case, the method waits for the corresponding event at block 314. Conversely, the automation server at block 316 calls the service handler on the automation agent of the test client (passing the name of the desired service and any parameter). In response thereto, the flow of activity branches at block 318 (in the swim-lane of the automation agent) according to the type of service. Particularly, if the service consists of the request of opening a new web page the blocks 320-358 are executed, whereas if the service consists of the request of submitting a command on a web page already available the block 360 is executed; in both cases, the method then passes to block 362 (described in the following).

Considering in particular block 320 (new web page), the automation agent updates the opening request to as to identify itself as a web proxy for the browser. Particularly, the opening request specifies the desired web page through its URL (Uniform Resource Locator). The URL consists of the name of the protocol to be used to access the web page, the address of the test server wherein the web page is stored, and a pathname of the web page specifying its location on the test server. For example, a web page “myPage” on the test server “myServer”, which is accessed using the Hypertext Transfer Protocol (HTTP) will be identified by the following URL:
http://myServer/myPage
   The automation agent replaces the address of the test server with the one assigned thereto (after saving the original opening request). The address of the automation agent specifies the test client itself (by means of the predefined constant “localhost” corresponding to the address 127.0.0.1) and the port assigned to the automation agent. In the example at issue (assuming that the automation agent works on the port “myPort”), the URL will become:
http://localhost:myPort/myPage
   The flow of activity then continues to block 322, wherein the automation agent launches the browser by passing the updated opening request (“http://localhost:myPort/myPage”).

In response thereto, the browser at block 324 requests the desired web page to the automation agent (“myPage”). The automation agent at block 326 restores the original opening request by inserting the address of the test server (“myServer”). Continuing to block 328, the automation agent submits the original opening request to the test server. As a consequence, the test server at block 330 sends the desired web page to the automation agent. Referring now to block 332 in the swim-lane of the automation agent, the web page is updated by inserting (at the beginning) a HTML tag identifying an automation applet; this automation applet (available on the test server) will be used to simulate all the human interactions with the web page (for example, filling a form, clicking a button, and the like). Likewise, the automation agent at block 334 also insert the code of a management script into the web page; this management script will act as an interface between the automation applet and the web page (for example, informing the automation applet about the structure of the web page and notifying the completion of the loading of the web page to the automation server). The web page so updated is then returned to the browser at block 336.

For example, a generic web page is defined by the following HTML code (between the start tag <HTML> and the end tag <\HTML>):

<HTML>
<HEAD>
...
</HEAD>
<BODY>
...
</BODY>
</HTML>

wherein a head portion (between the tags <HEAD> and </HEAD>) defines what the page is about and a body portion (between the tags <BODY> and </BODY>) defines the information to be included in the web page. Denoting with “myApplet” the name of the automation applet and with “myScript” the code of the management script, the web page will be updated by the automation agent as follows:

<HTML>
<HEAD>
...
</HEAD>
<BODY>
<APPLET name=myApplet classpath=myServer></APPLET>
...
<SCRIPT>

myScript

</SCRIPT>
</BODY>
</HTML>

Considering now block 338, the browser interprets the (updated) web page. Therefore, the first action performed by the browser at block 340 will be that of requesting the automation applet to the automation agent (as its web proxy). As a consequence, the automation agent submits the request to the test server at block 342. Proceeding to block 344, the test server fetches the automation applet and returns it to the automation agent. The method continues to block 346, wherein the automation agent forwards the automation applet to the browser. The browser can now launch the automation applet at block 348; in this respect, it should be noted that the location of the automation applet on the same test server from which the web page has been downloaded ensures that no security exception is raised by the browser.

The flow of activity continues to block 350 in the swim-lane of the automation applet, wherein a unique identifier for the automation applet is generated (for example, using a current timestamp). Proceeding to block 352, the automation applet opens a communication socket (defining a virtual connection identified by a network address and a port number) with the automation agent; in this phase, the automation applet passes its identifier to the automation agent (so as to allow the automation agent to distinguish possible automation applets relating to different instances of the browser that are running concurrently on the test client). The automation agent then remains listening on this communication socket at block 354.

In the meanwhile, the browser continues interpreting the web page. Once the loading of the web page has been completed, the flow of activity descends into block 356; at this point, the browser executes the management script that informs the automation agent of the completion of the loading of the web page. The automation agent notifies the automation server accordingly at block 358 (so as to exit from any waiting loop at block 314).

Referring back to block 318, whenever the automation server requests a service to the automation agent for submitting a command on the web page (already loaded) the flow of activity descends into block 360; in this case, the automation agent passes the command to the automation applet (through the corresponding communication socket). The operation returns immediately, without waiting for the result of the execution of the command.

In any case (following the request for a service relating to either a new web page or a command on an available web page), a test is made at block 362 to determine whether the last instruction of the test case has been processed. If not, the test client is unlocked at block 363; the method then returns to block 308 for repeating the same operations for a next instruction. Once the test case has been completed, the method ends at the concentric black/white stop circles 364 (with the test client that is automatically unlocked).

In the meanwhile, each command that has been passed to the automation applet is converted into JavaScript instructions and then passed to the corresponding engine of the browser at block 366; for example, this operation is performed using the LiveConnect technology (which allows the interaction of different objects, such as applets, JavaScripts, HTML elements as forms, buttons and images). Moving now to block 368 in the swim-lane of the browser, those JavaScript instructions are interpreted to cause the execution of the desired command on the web page. The method branches at decision block 370 according to the type of command that has been executed. If the command does not involve the closing of the web page, its return code is passed by the browser to the automation applet at block 372. Whenever an error has occurred (decision block 374), this code is returned to the automation agent at block 376. The automation agent in turn forwards the information to the automation server at block 378. In response thereto, the automation server at block 380 stops the execution of the test case; the method then ends at the final circles 364 (unlocking the test client). Conversely, when the execution of the command has been successful the automation applet returns to block 354 in order to listen for a next command.

Referring back to block 370, if the command involves the closing of the web page (for example, because another web page has been requested) the browser at block 382 notifies the event to all the associated applets (by calling a corresponding method “destroy”). In response thereto, the automation applet at block 384 closes the communication socket with the automation agent. The method then passes to block 386, wherein the automation applet is removed from the memory of the test client.

It should be noted that all the instructions of the test case are synchronous; in other words, the control returns only after the instructions have been executed. This allows serializing the operations to be executed on the test clients, so as to simulate the human intervention of the testers. In this respect, particular attention must be paid to an instruction “OpenBrowser” that is used to open the browser with a specific web page. This instruction is synchronous as well, being completed when the browser has been launched and it is running (even if the required web page is not entirely loaded). However, since no command can be submitted on the web page before its loading, an instruction “waitForPage” is used to suspend the execution of the test case until the web page has been completely loaded. For example, the following test case:
openBrowser(myServer,myPage);
waitForPage( );
myField.setText(myText1);
submit clear( );
myField.setText(myText2);
submit click( );
   will cause the loading of the web page “myPage” from the test server “myServer”. Once the loading of the web page has been completed (“waitForPage”), the text “myText1” is written into the field “myField”. The command “clear” is then used to clear the field. A new text (“myText2”) is written into the same field “myField”. The command “click” then causes the transmission of the entered information to the test server.

An exception to the above-described behavior is given by an instruction “runProcess”, which is used to start a generic program. In this case, the instruction can be either synchronous (when it is necessary to wait for the program to run before executing a next instruction) or asynchronous (for example, when the program runs in the background during the execution of the entire test case).

Although the present invention has been described above with a certain degree of particularity with reference to preferred embodiment(s) thereof, it should be understood that various omissions, substitutions and changes in the form and details as well as other embodiments are possible. Particularly, it is expressly intended that all combinations of those elements and/or method steps that substantially perform the same function in the same way to achieve the same results are within the scope of the invention. Moreover, it should be understood that specific elements and/or method steps described in connection with any disclosed embodiment of the invention may be incorporated in any other embodiment as a general matter of design choice.

For example, even though in the preceding description reference has been made to a web application and to web pages, this is not to be intended as a limitation; more generally, the solution of the invention can be applied to test any other software application that involves the loading of generic pages (formatted in whatever language). Likewise, the reference to the applets is merely illustrative and the same results can be achieved with automation components written in any other language (preferably of the interpreted type). Alternatively, the automation server communicates with the automation agent using generic Remote Procedure Calls (RPC) or message queuing methods, or the automation applet executes the desired commands on the web page exploiting another technology.

Similar considerations apply if the web page is identified by equivalent information (specifying the address of the test server wherein the web page is stored).

In any case, the solution of the invention is suitable to be implemented even inserting a different code portion into the web page to cause the loading of the automation component (for example, inserting its instructions directly into the web page).

Alternatively, any other connection can be opened between the automation applet and the automation agent.

Likewise, it is possible to generate the unique identifier for the automation applet in a different way (for example, using a counter).

Moreover, the management script as well leads itself to be written in another (preferably interpreted) language; similar considerations apply if whatever code portion is inserted into the web page to cause the browser to notify the completion of the loading of the web page to the automation agent.

In any case, the programs and the corresponding data can be structured in a different way, or additional modules or functions can be provided.

It is also possible to distribute the programs in any other computer readable medium (such as a DVD).

Alternatively, the proposed solution can be implemented in a data processing system with another architecture (for example, based on a LAN), or even including a different number of test clients and/or test servers (down to a single one); likewise, each computer can include equivalent units, or can consist of a generic data processing entity (such as a PDA, a mobile phone, and the like).

Moreover, it will be apparent to those skilled in the art that the additional features providing further advantages are not essential for carrying out the invention, and may be omitted or replaced with different features.

For example, the use of other techniques for intercepting the loading of each web page by the automation agent (even not acting as a web proxy for the browser) is contemplated.

Moreover, it is also possible to associate the automation applet with the web page in a different way.

In any case, an implementation of the invention with the automation applet that is stored elsewhere (for example, on the same test client) is feasible.

It is also tenable to implement alternative communication methods between the automation applet and the automation agent.

The solution of the invention leads itself to be put into practice even without any identifier for the automation applet (when a single instance of the browser is supported).

In addition, an embodiment completely asynchronous (without the use of any management script) is not excluded in some specific applications.

Alternatively, the programs are pre-loaded onto the hard disks, are sent to the computers through the network, are broadcast, or more generally are provided in any other form directly loadable into the working memories of the computers.

However, the method according to the present invention leads itself to be carried out with a hardware structure (for example, integrated in chips of semiconductor material), or with a combination of software and hardware.

Naturally, in order to satisfy local and specific requirements, a person skilled in the art may apply to the solution described above many modifications and alterations all of which, however, are included within the scope of protection of the invention as defined by the following claims.

1. A method for testing a distributed software application running in a data processing system with at least one test client and at least one test server, for each test client the method including the steps of:
an automation server transmitting a request of opening a page stored on a corresponding test server to an automation agent running on the test client,
the automation agent causing the loading of the page with the addition of an automation component,
the automation server transmitting a command for the page to the automation agent,
the automation agent passing the command to the automation component, and
the automation component causing the execution of the command on the page.

2. The method according to claim 1, wherein the request of the page includes an address of the test server storing the page and a name of the page, the step of causing the loading of the page with the addition of the automation component including:
updating the request by replacing the address of the test server with an address of the automation agent,
opening a browser by passing the updated request,
receiving a downloading command including the name of the page from the browser,
downloading the page from the test server,
updating the page to cause the loading of the automation component, and
returning the updated page to the browser to cause the browser to interpret the updated page.

3. The method according to claim 2, wherein the step of updating the page includes:
inserting a code portion into the page to cause the browser to fetch and run the automation component during the interpretation of the page.

4. The method according to claim 3, wherein the automation component is stored on the test server.

5. The method according to claim 1, further including the steps under the control of the automation component of:
opening a connection with the automation agent, and
listening for the command on the connection.

6. The method according to claim 1, further including the steps under the control of the automation component of:
generating a unique identifier of the automation component, and
passing (352) the identifier to the automation agent.

7. The method according to claim 1, wherein the step of updating the page further includes:
inserting a further code portion into the page to cause the browser to notify the completion of the loading of the page to the automation agent, the automation agent forwarding the notification to the automation server.

8. A computer program including program code means directly loadable into a working memory (159) of a data processing system for performing the method of claim 1 when the program is run on the system.

9. (canceled)

10. A data processing system including at least one test client and at least one test server for running a distributed software application, and an automation server for testing the software application, wherein each test client includes an automation agent and wherein the automation server includes means for transmitting a request of opening a page stored on a corresponding test server to the automation agent, the automation agent causing the loading of the page with the addition of an automation component, and means for transmitting a command for the page to the automation agent, the automation agent passing the command to the automation component and the automation component causing the execution of the command on the page.
